(19) United States
(12) Patent Application Publication
(10) Pub. No.: US 2026/0121230 A1
(43) Pub. Date: Apr. 30, 2026

(54) ELECTRODE ASSEMBLY, METHOD FOR MANUFACTURING ELECTRODE ASSEMBLY, AND SECONDARY BATTERY INCLUDING ELECTRODE ASSEMBLY

(71) Applicant: SAMSUNG SDI CO., LTD., Yongin-si (KR)

(72) Inventor: Seungyong CHOI, Yongin-si (KR)

(21) Appl. No.: 19/077,228

(22) Filed: Mar. 12, 2025

(30) Foreign Application Priority Data
Oct. 24, 2024 (KR) 10-2024-0146755

(51) Int. Cl. H01M 50/46; C09J 5/06; C09J 7/35; H01M 10/0525; H01M 10/0587; H01M 50/406; H01M 50/414

(52) U.S. Cl. CPC H01M 50/461; C09J 5/06; C09J 7/35; H01M 10/0525; H01M 10/0587; H01M 50/406; H01M 50/414; C09J 2203/33; C09J 2301/204; C09J 2301/304

(57) ABSTRACT

An electrode assembly, including a first electrode, a first separator on the first electrode, a second electrode on the first separator, a second separator on the second electrode, a winding including the first electrode, the second electrode, the first separator, and the second separator, wherein the second separator surrounds outer circumferences of the first electrode, the second electrode, and the first separator, resulting in a wound second separator, and an adhesive layer within the wound second separator.

### CROSS-REFERENCE TO RELATED APPLICATION

The present application claims priority to and the benefit of Korean Application No. 10-2024-0146755, filed on Oct. 24, 2024, in the Korean Intellectual Property Office, the entire disclosure of which is incorporated by reference herein.

### BACKGROUND

### 1. Field

The present disclosure relates to an electrode assembly, a method for manufacturing the electrode assembly, and a secondary battery including the electrode assembly.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include an electrode assembly, including a first electrode, a first separator on the first electrode, a second electrode on the first separator, a second separator on the second electrode, a winding including the first electrode, the second electrode, the first separator, and the second separator, wherein the second separator surrounds outer circumferences of the first electrode, the second electrode, and the first separator, resulting in a wound second separator, and an adhesive layer within the wound second separator.

The adhesive layer may not directly overlap a winding terminal end of the first separator.

The adhesive layer may include one of a thermoplastic resin and a thermosetting resin.

The adhesive layer may extend along an inner surface of the second separator from a winding terminal end of the second separator.

The adhesive layer may surround an outer circumference of the electrode assembly by at least one turn.

A width of the adhesive layer may correspond to a width of at least one of the first separator and the second separator.

A thickness of the adhesive layer may correspond to a thickness of the first separator.

Embodiments include a secondary battery, including an electrode assembly, which includes a first electrode, a first separator on the first electrode, a second electrode disposed on the first separator, and a second separator on the second electrode, in which the first electrode, the second electrode, the first separator, and the second separator are wound such that the second separator surrounds outer circumferences of the first electrode, the second electrode, and the first separator, resulting in a wound second separator, the electrode assembly further including an adhesive layer within the wound second separator, a case including a bottom portion, a side wall portion connected to the bottom portion, and an opening facing the bottom portion, the case accommodating the electrode assembly, and a cap assembly sealing the case by being bonded with one end of the side wall portion adjacent the opening.

The adhesive layer may not overlap the first separator.

The adhesive layer may include a thermoplastic resin or a thermosetting resin.

The adhesive layer may extend along an inner surface of the second separator from a winding terminal end of the second separator, and the adhesive layer surrounds an outer circumference of the electrode assembly by at least one turn.

A width of the adhesive layer may correspond to a width of at least one of the first separator and the second separator, and a thickness of the adhesive layer corresponds to a thickness of the first separator.

The secondary battery may be a coin cell battery or a button cell battery.

The second separator may contact an inner side of the side wall portion of the case.

Embodiments include a method for manufacturing an electrode assembly, the method including preparing a first electrode, a first separator, a second electrode, and a second separator, disposing an adhesive layer extending along one surface of the second separator from one end of the second separator, sequentially stacking and winding the first electrode, the first separator, the second electrode, and the second separator, and fixing shapes of the first electrode, the first separator, the second electrode, and the second separator that are wound using the adhesive layer, resulting in a winding and a wound second separator, wherein the winding includes the second separator surrounding outer circumferences of the first electrode, the second electrode, and the first separator, and the adhesive layer is interposed within the wound second separator.

A width of the adhesive layer may correspond to a width of at least one of the first separator and the second separator, and a thickness of the adhesive layer may correspond to a thickness of the first separator.

Disposing the adhesive layer may include disposing the adhesive layer to surround an outer circumference of the electrode assembly by at least one turn.

The winding may further include cutting the first separator and the second separator.

The adhesive layer may include a thermoplastic resin, and the fixing may include melting the adhesive layer by applying heat to the adhesive layer, and cooling the adhesive layer.

The adhesive layer may include a thermosetting resin, and the fixing may include applying heat to the adhesive layer to harden the adhesive layer.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of ordinary skill in the art by describing in detail exemplary embodiments with reference to the attached drawings, in which:

FIG. 1 is a sectional view of a secondary battery according to one or more embodiments of the present disclosure;

FIG. 2 is a plan view illustrating a state before winding of an electrode assembly according to one or more embodiments of the present disclosure;

FIG. 3 is a cross-sectional view illustrating a state after winding of the electrode assembly according to one or more embodiments of the present disclosure;

FIG. 4 is a plan view illustrating a state before winding of the electrode assembly according to one or more embodiments of the present disclosure;

FIG. 5 is a cross-sectional view illustrating a state after winding of the electrode assembly according to one or more embodiments of the present disclosure;

FIG. 6 is a plan view illustrating a state before winding of the electrode assembly according to one or more embodiments of the present disclosure;

FIG. 7 is a cross-sectional view illustrating a state after winding of the electrode assembly according to one or more embodiments of the present disclosure;

FIG. 8 is a plan view and a side view illustrating a state before winding of the first and second separators according to one or more embodiments of the present disclosure;

FIG. 9 is a sectional view illustrating an example of the wound electrode assembly of which a diameter is reduced according to one or more embodiments of the present disclosure;

FIG. 10 is a flowchart illustrating a method for manufacturing an electrode assembly according to one or more embodiments of the present disclosure; and

FIG. 11 is a flowchart illustrating a method for manufacturing a secondary battery according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her embodiments in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

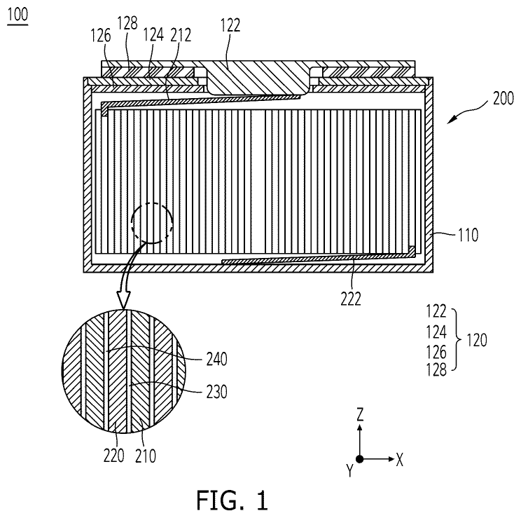

FIG. 1 is a sectional view of a secondary battery 100 according to one or more embodiments of the present disclosure.

In the present disclosure, the secondary battery 100 may refer to a secondary battery including a wound-type electrode assembly. For example, the secondary battery 100 may be a coin cell battery, a cylindrical battery, or a pin-shaped battery, but may not be limited thereto. Hereinafter, a case where the secondary battery 100 is a coin cell battery having a relatively small size will be described as an example.

Here, a coin cell battery or a button cell battery may mean a battery having a shape of a thin coin or a button, may mean a battery of which a ratio of height to diameter (height/diameter) is equal to or smaller than 1, but may vary. As a coin cell battery or a button cell battery mainly has a cylindrical shape, a horizontal cross-section of the battery may have a circular shape, but the horizontal cross-section may have an oval shape or a polygonal shape as well. Here, the diameter may mean a maximum distance in a horizontal direction of the battery, and the height may mean a maximum distance (a distance from a flat bottom surface to a flat top surface) in a vertical direction of the battery.

Referring to FIG. 1, the secondary battery 100 may include an electrode assembly 200, a case 110 that accommodates the electrode assembly and an electrolyte therein, and a cap assembly 120 that is bonded to an opening of the case 110 to seal the case 110. The cap assembly 120 may include a cap plate 124 that is bonded to the opening of the case 110, a terminal plate 122 that is insulated from the cap plate 124, an insulating layer 128 that insulates the terminal plate 122 and the cap plate 124, and an insulating member 126 that is disposed between the electrode assembly and the cap plate 124 in the case 110.

In one or more embodiments, the case 110 may accommodate the electrode assembly 200 and the electrolyte, and form an outer shape of the secondary battery together with the cap assembly 120. The case 110 may include a side wall portion having a roughly cylindrical shape and a bottom portion connected to one end of the side wall portion. However, the case 110 may be configured in various shapes such as a circle or a polygon.

Further, the case 110 may be made of a metal such as aluminum, aluminum alloy, nickel-plated steel, or the like. Here, any material, which is chemically resistant to an electrolyte, is conductive, and is commonly used in the industry, may be used.

The terminal plate 122 may be electrically connected to the electrode assembly. The terminal plate 122 may be physically connected to the electrode assembly via a first electrode tab 212 and like. The terminal plate 122 may be electrically insulated from the cap plate 124 via the insulating layer 128. Further, the terminal plate 122 may be bonded to the cap plate 124 via the insulating layer 128. In this manner, the terminal plate 122 may serve as an electrode terminal. Referring to FIG. 1, the terminal plate 122 may include a lower protrusion portion and an upper flange portion, and the protrusion portion may be inserted into an opening formed at the center of the cap plate 124. Further, the insulating member 126 may be disposed such that the electrode assembly or the first electrode tab 212 connected to the electrode assembly is insulated from the cap plate 124. For example, as illustrated in FIG. 1, the first electrode tab 212 of the electrode assembly may contact the protrusion portion of the terminal plate 122. Thereby, the insulating member 126 may be disposed between the cap plate 124 and the electrode assembly, except for a portion where the protrusion portion of the terminal plate 122 is located.

In one or more embodiments, the electrode assembly accommodated in the case 110 may be configured by winding a laminate including a first electrode 210, a first separator 230 disposed on the first electrode 210, a second electrode 220 disposed on the first separator 230, and a second separator 240 disposed on the second electrode 220 in a jelly-roll shape. For example, the wound-type electrode assembly may be formed in a structure having a cross-section of a cylindrical shape or an oval shape, by winding an anode and a cathode having a long sheet shape in a dense state. Referring to FIG. 1, lengths of the first electrode 210, the second electrode 220, the first separator 230, and the second separator 240 in the width direction (e.g., the Y-axis direction) may be illustrated as being the same size. This structure may be a simplified schematic structure of the electrode assembly, but may vary.

The first electrode 210 may include a first substrate and a first active material layer disposed on the first substrate. From a first non-coating portion of the first substrate at which the first active material layer is not disposed, the first electrode tab 212 or a first lead tab may extend outward from the electrode assembly 200. The first electrode tab 212 or the first lead tab may be electrically connected to the cap assembly 120. As a specific example, the first electrode tab 212 or the first lead tab may be electrically connected to the terminal plate 122. In one or more embodiments, the terminal plate 122 may protrude outside the secondary battery 100, and serve as a first electrode terminal.

The second electrode 220 may include a second substrate and a second active material layer disposed on the second substrate. From a second non-coating portion of the second substrate at which the second active material layer is not disposed, the second electrode tab 222 or a second lead tab may extend outward. The second electrode tab 222 or the second lead tab may be electrically connected to the case 110. In one or more embodiments, the case 110 may serve as a second electrode terminal.

As illustrated in FIG. 1, the first electrode tab 212 and the second electrode tab 222 in the electrode assembly 200 may extend in opposite directions. In one or more embodiments, the first lead tab and the second lead tab in the electrode assembly may extend in opposite directions. Further, the first electrode 210 may function as an anode. In one or more embodiments, the first substrate may be made of, for example, aluminum foil, and the first active material layer may include, for example, a transition metal oxide. In one or more embodiments, the second electrode 220 may function as a cathode. In one or more embodiments, the second substrate may be made of, for example, copper foil or nickel foil, and the second active material layer may include, for example, graphite. In one or more embodiments, the first electrode 210 may function as a cathode and the second electrode 220 may function as an anode.

The separators 230 and 240 may have a function of preventing a short circuit between the first electrode 210 and the second electrode 220 while allowing movement of lithium ions in the lithium secondary battery. The separators 230 and 240 may be made of, for example, a polyethylene film, a polypropylene film, a polyethylene-polypropylene film, or the like.

In one or more embodiments, the wound-type electrode assembly 200 as described above may end with the first separator 230 or the second separator 240. The first separator 230 and the second separator 240 may be wound to surround outer circumferences of the first electrode 210 and the second electrode 220. As a specific example, the second separator 240 may be wound to surround outer circumferences of the first electrode 210, the second electrode 220, and the first separator 230.

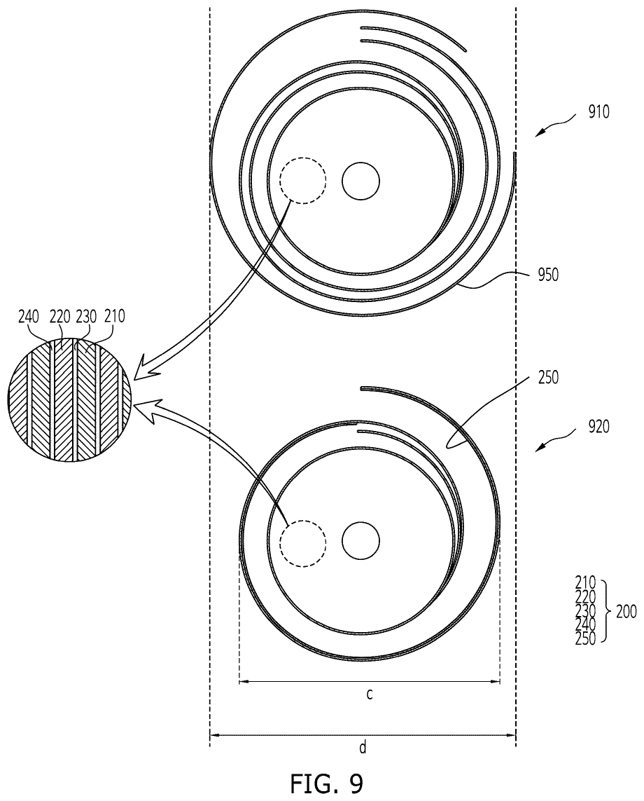

Further, in the electrode assembly of the secondary battery 100 according to one or more embodiments of the present disclosure, a finishing tape surrounding an outermost portion of the electrode assembly may be omitted. Thus, the second separator 240, which is wound to surround the outer circumferences of the first electrode 210, the second electrode 220, and the first separator 230, may contact an inner side of the side wall portion of the case 110. An example of the form of the electrode assembly in which the finishing tape is omitted will be described in detail below with reference to FIG. 9.

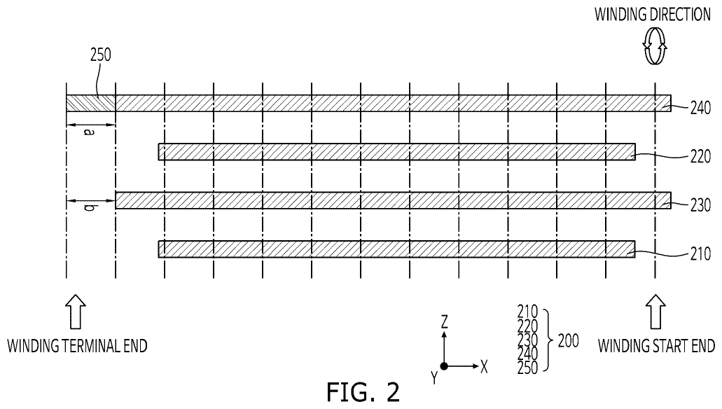

FIG. 2 is a plan view illustrating a state before winding of an electrode assembly 200 according to one or more embodiments of the present disclosure.

The electrode assembly 200 may include a first electrode 210, a first separator 230 disposed on the first electrode 210, a second electrode 220 disposed on the first separator 230, a second separator 240 disposed on the second electrode 220, and an adhesive layer 250. In one or more embodiments, the adhesive layer 250 may be interposed in the middle of (e.g., within or on the inside of) the wound second separator 240. As a specific example, the adhesive layer 250 may extend along an inner surface of the second separator 240 from a winding terminal end of the second separator 240 such that the adhesive layer 250 is interposed in the middle of the wound second separator 240.

The first electrode 210 may be an electrode corresponding to an anode or a cathode in a secondary battery. The second electrode 220 may be an electrode corresponding to the opposite electrode of the first electrode 210. For example, in a case where the first electrode 210 is an anode, the second electrode 220 may be a cathode. In a case where the first electrode 210 is a cathode, the second electrode 220 may be an anode.

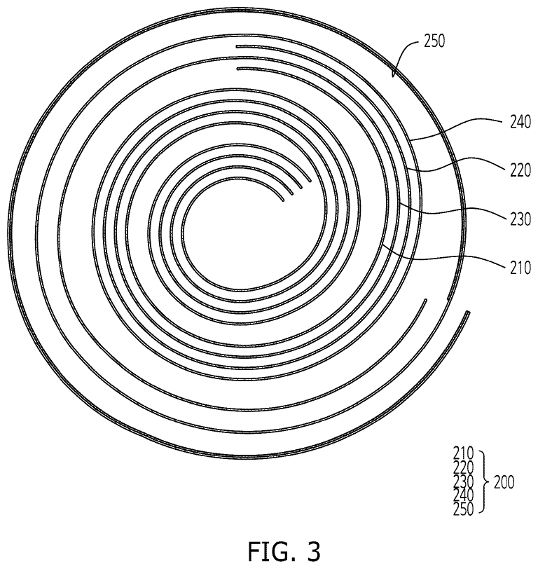

In FIG. 2, each of a plurality of dotted lines drawn in a vertical direction indicates a winding turn number corresponding to one turn based on the wound electrode assembly 200. In practice, as the winding turn number increases, an interval between the dotted lines gradually increases. However, for ease of understanding the present disclosure, the dotted lines with a constant interval are illustrated in FIG. 2. For this reason, FIG. 2 may not exactly match the wound electrode assembly 200 illustrated in FIG. 3, described below.

In FIG. 2, a right end may correspond to a winding start end, and a left end may correspond to a winding terminal end (i.e., the winding goes from right to left in the orientation of FIG. 2). The winding start end may refer to an area where winding begins in a winding process of the electrode assembly 200, and the winding terminal end may refer to an area where winding is terminated in a winding process of the electrode assembly 200. The winding terminal end may be located on an outer circumference of the electrode assembly 200. It may be assumed that a winding direction is a counterclockwise direction. These features and assumptions may be shared in all embodiments of the present disclosure.

In one or more embodiments, the adhesive layer 250 may be disposed to surround the outer circumference of the electrode assembly 200 by one turn (e.g., at least one turn). Here, the outer circumference may not refer only to the outermost circumference of the electrode assembly 200. For example, the second separator 240 may be disposed on the outermost circumference of the electrode assembly 200, and the adhesive layer 250 may be disposed on an inner side of the outermost second separator 240. Thereby, it is possible to prevent movement of the electrode assembly 200 due to a drop impact and/or a collision of the secondary battery, and to prevent an empty space that may occur in a case of fixing an outermost portion of the electrode assembly 200 with a finishing tape.

In one or more embodiments, the adhesive layer 250 may not overlap the first separator 230. As a specific example, the adhesive layer 250 may not overlap (e.g., may not directly overlap) the winding terminal end of the first separator 230.

The number-of-turns a of the adhesive layer 250 may refer to the number of times the adhesive layer 250 surrounds the wound electrode assembly 200 based on the winding turn number indicated by the dotted lines. The number-of-turns b of a distance between the winding terminal end of the second separator 240 and the winding terminal end of the first separator 230 may mean the number of times the wound electrode assembly 200 is surrounded by the distance between the winding terminal end of the second separator 240 and the winding terminal end of the first separator 230 based on the winding turn number indicated by the dotted lines. In one or more embodiments, the number-of-turns a of the adhesive layer 250 may correspond to the number-of-turns b of the distance between the winding terminal end of the second separator 240 and the winding terminal end of the first separator 230.

In one or more embodiments, the adhesive layer 250 may include a thermoplastic resin or a thermosetting resin. As a specific example, the adhesive layer 250 may include a thermoplastic resin or a thermosetting resin that is chemically resistant to the electrolyte.

In one or more embodiments, a width (e.g., in the X-axis direction) of the adhesive layer 250 may correspond to (e.g., equal) a width of at least one of the first separator 230 or the second separator 240. As a specific example, in a case where the width of the first separator 230 is wider than the width of the second separator 240, the width of the adhesive layer 250 may correspond to the width of the second separator 240, and in a case where the width of the first separator 230 is narrower than the width of the second separator 240, the width of the adhesive layer 250 may correspond to the width of the first separator 230. A thickness (e.g., the Z-axis direction) of the adhesive layer 250 may correspond to a thickness of the first separator 230.

FIG. 3 is a cross-sectional view illustrating a state after winding of the electrode assembly 200 according to one or more embodiments of the present disclosure.

The electrode assembly 200 illustrated in FIG. 2 is in a state before winding, and the electrode assembly 200 illustrated in FIG. 3 is in a state after winding. The electrode assembly 200 illustrated in FIG. 2 and the electrode assembly 200 illustrated in FIG. 3 may have slightly different external appearances. As the electrode assembly 200 accommodated in the case 110 is illustrated in FIG. 3, a relationship between the first electrode 210, the second electrode 220, the first separator 230, and the second separator 240 may be more accurately represented in the form illustrated in FIG. 3. Here, although the first electrode 210, the second electrode 220, the first separator 230, and the second separator 240 are in close contact with each other, these components are illustrated as being spaced apart from each other in FIG. 3 for ease of understanding the present disclosure.

The electrode assembly 200 may include the first electrode 210, the first separator 230 disposed on the first electrode 210, the second electrode 220 disposed on the first separator 230, the second separator 240 disposed on the second electrode 220, and the adhesive layer 250. In one or more embodiments, the adhesive layer 250 may be interposed in the middle of the wound second separator 240. As a specific example, the adhesive layer 250 may extend along the inner surface of the second separator 240 from the winding terminal end of the second separator 240 such that the adhesive layer 250 is interposed in the middle of the wound second separator 240.

The adhesive layer 250 may be disposed to surround the outer circumference of the electrode assembly 200 by one turn. As a specific example, the adhesive layer 250 may extend along the inner surface of the second separator 240 from the winding terminal end of the second separator 240 such that the adhesive layer 250 surrounds the outer circumference of the electrode assembly 200 by one turn. The adhesive layer 250 may not overlap (e.g., may not directly overlap) the first separator 230. As a specific example, the adhesive layer 250 may extend along the inner surface of the second separator 240 from the winding terminal end of the second separator 240 to the winding terminal end of the first separator 230 such that the adhesive layer 250 does not overlap the first separator 230.

In one or more embodiments, in the wound state, one end of the adhesive layer 250 may correspond to the winding terminal end of the second separator 240 in the circumferential direction, and the other end of the adhesive layer 250 may correspond to the winding terminal end of the first separator 230 in the circumferential direction.

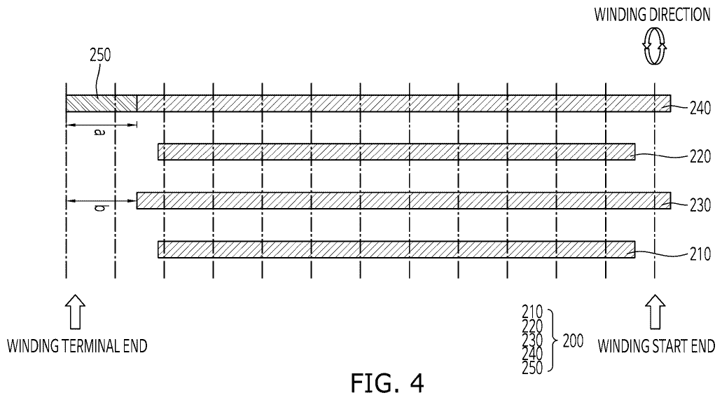

FIG. 4 is a plan view illustrating a state before winding of an electrode assembly 200 according to one or more embodiments of the present disclosure.

The electrode assembly 200 may include the first electrode 210, the first separator 230 disposed on the first electrode 210, the second electrode 220 disposed on the first separator 230, the second separator 240 disposed on the second electrode 220, and the adhesive layer 250. In one or more embodiments, the adhesive layer 250 may be interposed in the middle of the wound second separator 240. As a specific example, the adhesive layer 250 may extend along the inner surface of the second separator 240 from the winding terminal end of the second separator 240 such that the adhesive layer 250 is interposed in the middle of the wound second separator 240.

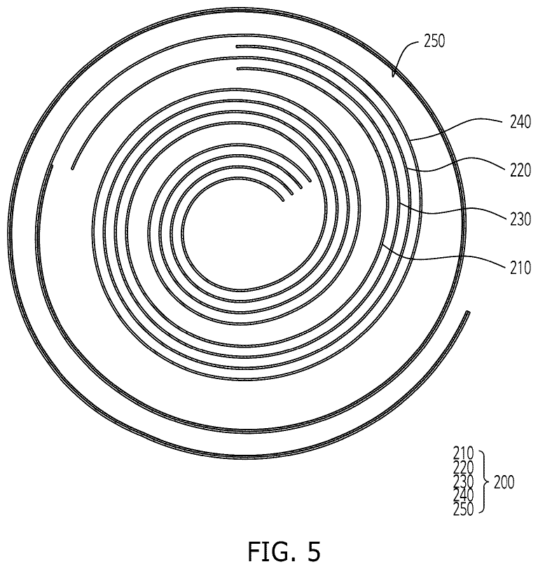

Similarly to FIG. 2, as the winding turn number increases, an interval between the dotted lines gradually increases, the dotted lines indicating the winding turn number corresponding to one turn based on the wound electrode assembly 200. However, for ease of understanding, the dotted lines with a constant interval are illustrated in FIG. 4. For this reason, FIG. 4 may not exactly match the wound electrode assembly 200 illustrated in FIG. 5 below.

In one or more embodiments, the adhesive layer 250 may be disposed to surround the outer circumference of the electrode assembly 200 by at least one turn (or one or more turns). Thereby, it is possible to prevent movement of the electrode assembly 200 due to a drop impact and/or a collision of the secondary battery, and to prevent an empty space that may occur in a case of fixing an outermost portion of the electrode assembly 200 with a finishing tape.

In one or more embodiments, the adhesive layer 250 may not overlap the first separator 230. As a specific example, the adhesive layer 250 may not overlap the winding terminal end of the first separator 230.

The number-of-turns a of the adhesive layer 250 may refer to the number of times the adhesive layer 250 surrounds the wound electrode assembly 200 based on the winding turn number indicated by the dotted lines. The number-of-turns b of a distance between the winding terminal end of the second separator 240 and the winding terminal end of the first separator 230 may mean the number of times the wound electrode assembly 200 is surrounded by the distance between the winding terminal end of the second separator 240 and the winding terminal end of the first separator 230 based on the winding turn number indicated by the dotted lines. In one or more embodiments, the number-of-turns a of the adhesive layer 250 may correspond to (e.g., match) the number-of-turns b of the distance between the winding terminal end of the second separator 240 and the winding terminal end of the first separator 230.

FIG. 5 is a cross-sectional view illustrating a state after winding of the electrode assembly 200 according to one or more embodiments of the present disclosure.

The electrode assembly 200 illustrated in FIG. 4 may correspond to a state before winding, and the electrode assembly 200 illustrated in FIG. 5 may correspond to a state after winding. In FIG. 4 and FIG. 5, the electrode assembly 200 may have slightly different external appearances. Because the electrode assembly 200 accommodated in the case 110 is illustrated in FIG. 4, a relationship between the first electrode 210, the second electrode 220, the first separator 230, and the second separator 240 may be more accurately represented in the form illustrated in FIG. 5. Here, although the first electrode 210, the second electrode 220, the first separator 230, and the second separator 240 are in close contact with each other, these components are illustrated as being spaced apart from each other in FIG. 5 for ease of understanding.

The adhesive layer 250 may be disposed to surround the outer circumference of the electrode assembly 200 by one or more turns. As a specific example, the adhesive layer 250 may extend along the inner surface of the second separator 240 from the winding terminal end of the second separator 240 such that the adhesive layer 250 surrounds the outer circumference of the electrode assembly 200 by one or more turns.

The adhesive layer 250 may not overlap the first separator 230. As a specific example, the adhesive layer 250 may extend along the inner surface of the second separator 240 from the winding terminal end of the second separator 240 to the winding terminal end of the first separator 230 such that the adhesive layer 250 does not overlap the first separator 230.

In one or more embodiments, in the wound state, one end of the adhesive layer 250 may correspond to the winding terminal end of the second separator 240 in the circumferential direction, and the other end of the adhesive layer 250 may correspond to the winding terminal end of the first separator 230 in the circumferential direction.

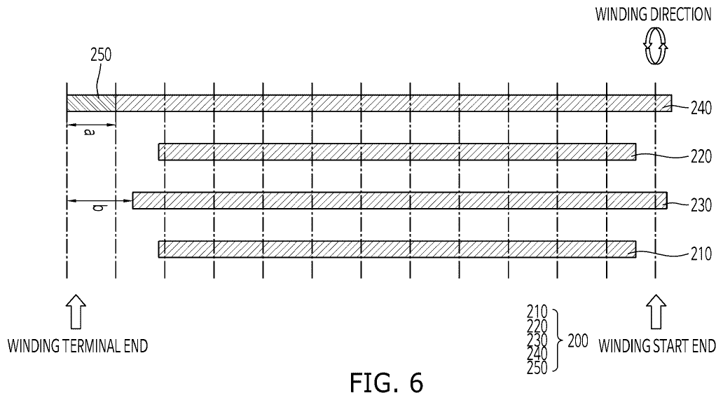

FIG. 6 is a plan view illustrating a state before winding of the electrode assembly 200 according to one or more embodiments of the present disclosure. In FIG. 6, an explanation of the components described or repeated in FIG. 2 and FIG. 4 will be omitted.

Referring to FIG. 6, the electrode assembly 200 may include the first electrode 210, the first separator 230 disposed on the first electrode 210, the second electrode 220 disposed on the first separator 230, the second separator 240 disposed on the second electrode 220, and the adhesive layer 250. In one or more embodiments, the adhesive layer 250 may extend along the inner surface of the second separator 240 from the winding terminal end of the second separator 240 such that the adhesive layer 250 is interposed in the middle of the wound second separator 240.

In one or more embodiments, the adhesive layer 250 may be disposed to surround the outer circumference of the electrode assembly 200 by one turn. The disposition of the adhesive layer 250 may vary. The adhesive layer 250 may not overlap the first separator 230. As a specific example, the adhesive layer 250 may not overlap the winding terminal end of the first separator 230.

The number-of-turns a of the adhesive layer 250 may refer to the number of times the adhesive layer 250 surrounds the wound electrode assembly 200 based on the winding turn number indicated by the dotted lines. The number-of-turns b of a distance between the winding terminal end of the second separator 240 and the winding terminal end of the first separator 230 may mean the number of times the wound electrode assembly 200 is surrounded by the distance between the winding terminal end of the second separator 240 and the winding terminal end of the first separator 230 based on the winding turn number indicated by the dotted lines. In one or more embodiments, the number-of-turns a of the adhesive layer 250 may be smaller than the number-of-turns b of the distance between the winding terminal end of the second separator 240 and the winding terminal end of the first separator 230. With this configuration, the adhesive layer 250 may not overlap the winding terminal end of the first separator 230.

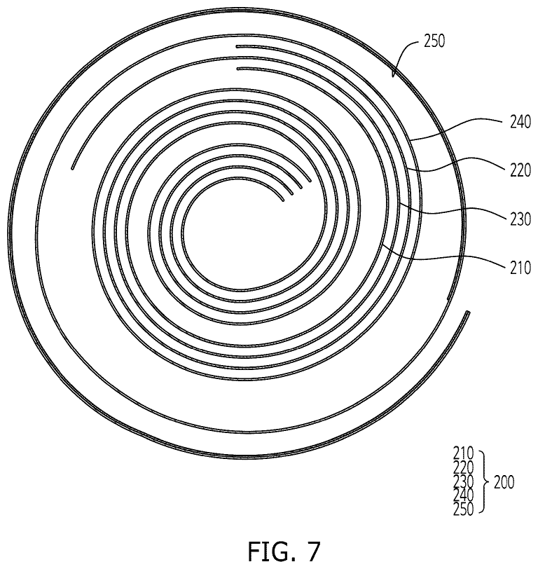

FIG. 7 is a cross-sectional view illustrating a state after winding of the electrode assembly 200 according to one or more embodiments of the present disclosure. In FIG. 7, an explanation of the components described or repeated in FIG. 3 and FIG. 5 will be omitted.

The adhesive layer 250 may be disposed to surround the outer circumference of the electrode assembly 200 by one turn, but the number of turns may be more than one. As a specific example, the adhesive layer 250 may extend along the inner surface of the second separator 240 from the winding terminal end of the second separator 240 such that the adhesive layer 250 surrounds the outer circumference of the electrode assembly 200 by one turn (e.g., at least one turn).

The adhesive layer 250 may not overlap the first separator 230. As a specific example, the adhesive layer 250 may extend along the inner surface of the second separator 240 from the winding terminal end of the second separator 240 to a portion spaced apart from the winding terminal end of the first separator 230 by a certain distance or more.

In one or more embodiments, in the wound state, one end of the adhesive layer 250 may correspond to the winding terminal end of the second separator 240 in the circumferential direction, and the other end of the adhesive layer 250 may not correspond to the winding terminal end of the first separator 230 in the circumferential direction.

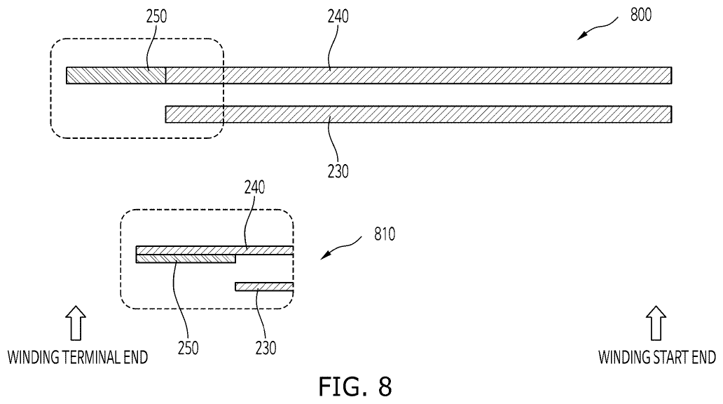

FIG. 8 is a plan view and a side view illustrating a state before winding of the first and second separators 230 and 240 according to one or more embodiments of the present disclosure.

In FIG. 8, a right end may correspond to a winding start end, and a left end may correspond to a winding terminal end. The winding start end may refer to an area where winding begins in a winding process of the electrode assembly 200, and the winding terminal end may refer to an area where winding is terminated in a winding process of the electrode assembly 200.

In one or more embodiments, a width of the adhesive layer 250 may correspond to (e.g., may equal) a width of at least one of the first separator 230 or the second separator 240. As a specific example, in a case where the width of the first separator 230 is wider than the width of the second separator 240, the width of the adhesive layer 250 may correspond to the width of the second separator 240, and in a case where the width of the first separator 230 is narrower than the width of the second separator 240, the width of the adhesive layer 250 may correspond to the width of the first separator 230. A thickness of the adhesive layer 250 may correspond to a thickness of the first separator 230.

In one or more embodiments, the adhesive layer 250 may include a thermoplastic resin or a thermosetting resin. As a specific example, the adhesive layer 250 may include a thermoplastic resin or a thermosetting resin that is chemically resistant to the electrolyte.

FIG. 9 is a sectional view illustrating an example of the wound electrode assembly 200 of which the diameter is reduced. A first example 910 may illustrate an electrode assembly according to a comparative example, and a second example 920 may illustrate the electrode assembly 200 according to the present disclosure.

Referring to FIG. 9, the electrode assembly according to the first example 910 may be a wound electrode assembly obtained by sequentially stacking a first electrode 210, a first separator 230, a second electrode 220, and a second separator 240. A finishing tape 950 may be attached to the outermost circumference of the wound electrode assembly to fix the electrode assembly.

In one or more embodiments, the secondary battery 100 may include the electrode assembly according to the first example 910. As a specific example, the secondary battery 100 may include the electrode assembly according to the first example 910 and a finishing tape 950 surrounding the outermost circumference of the electrode assembly. In one or more embodiments, an amount of the electrolyte that can be accommodated in the case may decrease by a thickness of the finishing tape 950. Thereby, the energy density of the secondary battery may be decreased. Further, there may be an empty space where the finishing tape 950 is not attached, and the empty space may further expand due to stress applied to the substrates as compared with other portions. As a result, a crack may occur on the substrates.

The second example 920 may correspond to the electrode assembly 200 according to one or more embodiments of the present disclosure. The electrode assembly 200 according to the second example 920 may be wound by sequentially stacking the first electrode 210, the first separator 230, the second electrode 220, and the second separator 240, and may further include the adhesive layer 250 interposed in the middle of the wound second separator 240. In one or more embodiments, the adhesive layer 250 may extend along the inner surface of the second separator 240 from the winding terminal end of the second separator 240 such that the adhesive layer 250 is interposed in the middle of the wound second separator 240.

Referring to the electrode assembly 200 according to the second example 920, in the electrode assembly 200 including the adhesive layer 250, the finishing tape 950 to be attached to the outermost circumference of the electrode assembly 200 may be omitted. With this configuration, a diameter c of the electrode assembly 200 according to the second example 920 may be smaller than a diameter d of the electrode assembly according to the first example 910.

Further, in the electrode assembly 200 according to the second example 920, it is possible to prevent an empty space that may occur in a case where the outermost circumference of the electrode assembly is fixed with the finishing tape 950 as in the electrode assembly according to the first example 910. Thereby, it is possible to prevent a crack that may occur in a case where the empty space further expands due to stress applied to the substrates as compared with other portions, and to prevent expansion of the substrates.

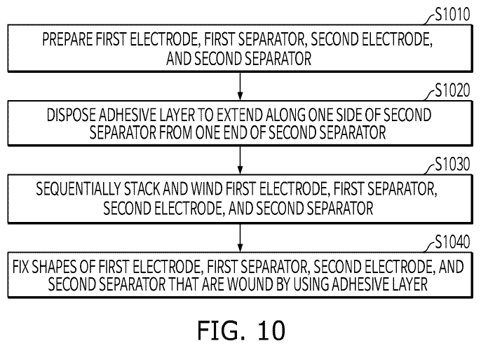

FIG. 10 is a flowchart illustrating a method for manufacturing an electrode assembly according to one or more embodiments of the present disclosure.

The method for manufacturing an electrode assembly may be started by preparing a first electrode, a first separator, a second electrode, and a second separator (S1010).

Next, an adhesive layer may be disposed to extend along one side of the second separator from one end of the second separator (S2000). The step of disposing the adhesive layer may include a step of disposing the adhesive layer such that the adhesive layer surrounds the outer circumference of the electrode assembly by one or more turns. Here, the adhesive layer may be interposed in the middle of the wound second separator. A width of the adhesive layer may correspond to a width of at least one of the first separator or the second separator, and a thickness of the adhesive layer may correspond to a thickness of the first separator.

Next, the first electrode, the first separator, the second electrode, and the second separator may be sequentially stacked and wound (S1030). The winding step may include a step of winding the second separator such that the second separator surrounds the outer circumferences of the first electrode, the second electrode, and the first separator. Further, the winding step may further include a step of cutting the first separator and the second separator.

Next, the shapes of the first electrode, the first separator, the second electrode, and the second separator that are wound may be fixed by using an adhesive layer (S1040). In one or more embodiments, the adhesive layer may include a thermoplastic resin, and the fixing step may include a step of melting the adhesive layer by applying heat to the adhesive layer and cooling the adhesive layer. In other embodiments, the adhesive layer may include a thermosetting resin, and the fixing step may include a step of hardening the adhesive layer by applying heat to the adhesive layer.

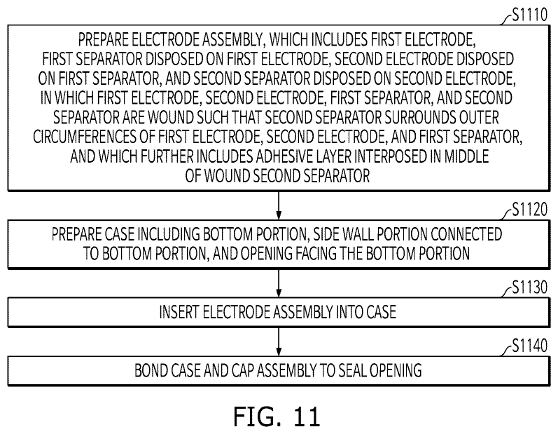

FIG. 11 is a flowchart illustrating a method for manufacturing a secondary battery according to one or more embodiments of the present disclosure.

A method for manufacturing a secondary battery may be started by preparing an electrode assembly, which includes a first electrode, a first separator disposed on the first electrode, a second electrode disposed on the first separator, and a second separator disposed on the second electrode, in which the first electrode, the second electrode, the first separator, and the second separator are wound such that the second separator surrounds outer circumferences of the first electrode, the second electrode, and the first separator, and which further includes an adhesive layer interposed in the middle of the wound second separator (S1110).

Next, a case including a bottom portion, a side wall portion connected to the bottom portion, and an opening facing the bottom portion may be prepared (S1120).

Next, the electrode assembly may be inserted into the case (S1130). The inserting step may include a step of connecting a first electrode tab connected to the first electrode with the cap assembly and a step of connecting a second electrode tab connected to the second electrode with the case.

Next, the case and the cap assembly may be bonded to each other to seal the opening (S1140). The sealing step may include a step of welding one end of the side wall portion of the case and the outer circumference surface of the cap plate.

In an electrode assembly that is included in a lithium-ion battery and includes electrodes and separators, expansion and contraction of substrates may occur due to insertion and separation of the lithium-ion battery during charging and discharging. The outermost circumference of the electrode assembly may be fixed with a finishing tape, and in this case, there may be an empty space where the finishing tape is not attached. In a case where the empty space further expands due to stress applied to the substrates as compared with other portions, a crack may occur on the substrates.

Further, along with the trend toward miniaturization and thinning of electronic devices that use secondary batteries, research on miniaturization and thinning of secondary batteries is being actively performed. In a case where a volume of a secondary battery is increased, the capacity of the battery may be increased, but there is a problem that it is disadvantageous for application to small devices. Therefore, it is desirable to increase the capacity of the secondary battery while maintaining or reducing the volume of the secondary battery.

According to one or more embodiments of the present disclosure, the first electrode, the second electrode, the first separator, and the second separator are wound such that the second separator surrounds outer circumference of the first electrode, the second electrode, and the first separator, and the adhesive layer is interposed in the middle of the second separator. Thereby, the finishing tape to be disposed on the outermost circumference of the electrode assembly may be omitted. Therefore, it is possible to secure more space in the secondary battery by the thickness of the finishing tape, and thus, it is possible to improve the energy density of the secondary battery.

According to one or more embodiments of the present disclosure, the adhesive layer that extends along an inner surface of the second separator from a winding terminal end of the second separator may be disposed. Thereby, it is possible to prevent movement of the electrode assembly due to a drop impact and/or a collision of the secondary battery. Therefore, it is possible to provide a secondary battery with improved stability.

According to one or more embodiments of the present disclosure, the adhesive layer is disposed to surround the outer circumference of the electrode assembly by at least one or more turns. Thus, it is possible to prevent an empty space that may occur in a case where the outermost circumference of the electrode assembly is fixed with a finishing tape. Thereby, it is possible to prevent a crack that may occur in a case where the empty space further expands due to stress applied to the substrates as compared with other portions, and to prevent expansion of the substrates.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### Description of Some Reference Symbols

100: secondary battery
110: case
120: cap assembly
200: electrode assembly
210: first electrode
212: first electrode tab
220: second electrode
222: second electrode tab
230: first separator
240: second separator
250: adhesive layer
950: closing tape

What is claimed is:

1. An electrode assembly, comprising:
a first electrode;
a first separator on the first electrode;
a second electrode on the first separator;
a second separator on the second electrode;
a winding including the first electrode, the second electrode, the first separator, and the second separator, wherein the second separator surrounds outer circumferences of the first electrode, the second electrode, and the first separator, resulting in a wound second separator; and
an adhesive layer within the wound second separator.

2. The electrode assembly as claimed in claim 1, wherein the adhesive layer does not directly overlap a winding terminal end of the first separator.

3. The electrode assembly as claimed in claim 1, wherein the adhesive layer includes one of a thermoplastic resin and a thermosetting resin.

4. The electrode assembly as claimed in claim 1, wherein the adhesive layer extends along an inner surface of the second separator from a winding terminal end of the second separator.

5. The electrode assembly as claimed in claim 1, wherein the adhesive layer surrounds an outer circumference of the electrode assembly by at least one turn.

6. The electrode assembly as claimed in claim 1, wherein a width of the adhesive layer corresponds to a width of at least one of the first separator and the second separator.

7. The electrode assembly as claimed in claim 1, wherein a thickness of the adhesive layer corresponds to a thickness of the first separator.

8. A secondary battery, comprising:
an electrode assembly, which includes a first electrode, a first separator on the first electrode, a second electrode disposed on the first separator, and a second separator on the second electrode, in which the first electrode, the second electrode, the first separator, and the second separator are wound such that the second separator surrounds outer circumferences of the first electrode, the second electrode, and the first separator, resulting in a wound second separator, the electrode assembly further including an adhesive layer within the wound second separator;
a case including a bottom portion, a side wall portion connected to the bottom portion, and an opening facing the bottom portion, the case accommodating the electrode assembly; and
a cap assembly sealing the case by being bonded with one end of the side wall portion adjacent the opening.

9. The secondary battery as claimed in claim 8, wherein the adhesive layer does not overlap the first separator.

10. The secondary battery as claimed in claim 8, wherein the adhesive layer includes a thermoplastic resin or a thermosetting resin.

11. The secondary battery as claimed in claim 8, wherein:
the adhesive layer extends along an inner surface of the second separator from a winding terminal end of the second separator, and
the adhesive layer surrounds an outer circumference of the electrode assembly by at least one turn.

12. The secondary battery as claimed in claim 8, wherein:
a width of the adhesive layer corresponds to a width of at least one of the first separator and the second separator, and
a thickness of the adhesive layer corresponds to a thickness of the first separator.

13. The secondary battery as claimed in claim 8, wherein the secondary battery is a coin cell battery or a button cell battery.

14. The secondary battery as claimed in claim 8, wherein the second separator contacts an inner side of the side wall portion of the case.

15. A method for manufacturing an electrode assembly, the method comprising:
preparing a first electrode, a first separator, a second electrode, and a second separator;
disposing an adhesive layer extending along one surface of the second separator from one end of the second separator;
sequentially stacking and winding the first electrode, the first separator, the second electrode, and the second separator; and
fixing shapes of the first electrode, the first separator, the second electrode, and the second separator that are wound using the adhesive layer, resulting in a winding and a wound second separator, wherein:
the winding includes the second separator surrounding outer circumferences of the first electrode, the second electrode, and the first separator, and
the adhesive layer is interposed within the wound second separator.

16. The method for manufacturing an electrode assembly as claimed in claim 15, wherein:
a width of the adhesive layer corresponds to a width of at least one of the first separator and the second separator, and
a thickness of the adhesive layer corresponds to a thickness of the first separator.

17. The method for manufacturing an electrode assembly as claimed in claim 15, wherein disposing the adhesive layer includes disposing the adhesive layer to surround an outer circumference of the electrode assembly by at least one turn.

18. The method for manufacturing an electrode assembly as claimed in claim 15, wherein the winding further includes cutting the first separator and the second separator.

19. The method for manufacturing an electrode assembly as claimed in claim 15, wherein:
the adhesive layer includes a thermoplastic resin, and
the fixing includes:
melting the adhesive layer by applying heat to the adhesive layer, and
cooling the adhesive layer.

20. The method for manufacturing an electrode assembly as claimed in claim 15, wherein:
the adhesive layer includes a thermosetting resin, and
the fixing includes applying heat to the adhesive layer to harden the adhesive layer.
